(19) United States
(12) Patent Application Publication
(10) Pub. No.: US 2022/0033302 A1
(43) Pub. Date: Feb. 3, 2022

(54) SPRAY MATERIAL FOR HOT AND DRY SPRAY APPLICATION, AND HOT AND DRY SPRAY APPLICATION METHOD

(71) Applicant: KROSAKIHARIMA CORPORATION, Fukuoka (JP)

(72) Inventor: Yousuke OONO, Fukuoka (JP)

(73) Assignee: KROSAKIHARIMA CORPORATION, Fukuoka (JP)

(21) Appl. No.: 17/281,369

(22) PCT Filed: Sep. 25, 2019
(86) PCT No.: PCT/JP2019/037464

§ 371 Date: Mar. 30, 2021

(30) Foreign Application Priority Data
Oct. 2, 2018 (JP) 2018-187646

(51) Int. Cl. C04B 14/28; C04B 28/26; C04B 28/34; F27D 1/16

(52) U.S. Cl. CPC C04B 14/28; C04B 28/26; C04B 2111/00163; F27D 1/16; C04B 28/344

(57) ABSTRACT

A spray material for hot and dry spray application with improved corrosion resistance, and a hot and dry spray application method with improved corrosion resistance. A hot and dry spray application method comprises pressure-feeding a mixture comprising a refractory material and a binder, toward a spraying nozzle via a pipe, and adding water to the mixture at a distal end of the spraying nozzle to apply a spray under a hot condition. The mixture contains magnesium limestone having a particle size of 0.075 mm to less than 1 mm, in an amount of 10 mass % to 50 mass %, in 100 mass % of a total amount of the refractory material and the binder. The content of magnesium limestone having a particle size of less than 0.075 mm in 100 mass % of the total amount of the refractory material and the binder is 35 mass % or less (including 0).

### TECHNICAL FIELD

The present invention relates to a spray material (unshaped refractory material) for hot and dry spray application, which is suitably used for hot repair of an industrial kiln/furnace, particularly, for a molten steel pot or a furnace body (furnace wall) of an electric furnace.

It is noted that the term “hot” means an environment in which the temperature of a to-be-applied surface (a surface to which a spray is to be applied) is approximately 600° C. or more.

### BACKGROUND ART

An application method for an unshaped refractory material varies depending on purposes of use. For example, when the unshaped refractory material is used as a castable material for a lining of an industrial kiln/furnace, it is applied after performing a refractory material-water mixture kneading step, a casting step, a curing step, and a drying step.

Further, there is another case where the unshaped refractory material is used as a spray material for construction or repair of an industrial kiln/furnace. In this case, an application method is roughly classified into a wet spray application method and a dry spray application method. The wet spray application method comprises: preliminarily kneading a spray material and water sufficiently by a mechanical kneading mechanism such as a mixer; pressure-feeding the resulting kneaded product toward a spraying nozzle by a pump; and introducing air and a set accelerating agent at a distal end of the spraying nozzle to perform spray application. The dry spray application method comprises: feeding a dry powder-form spray material without going through the mechanical kneading mechanism; and adding water to the spray material at the distal end of the spraying nozzle to perform spray application.

Generally, spray application using a spray material is performed under both hot and cold environments, and the dry spray application method is used under the two environments. However, the wet spray application method is generally not used under the hot environment. This is because the wet spray application method requires the preliminary kneading operation, and thus cleanup work such as cleaning work for a kneader and a feeding hose used during the pressure-feeding by the pump arises after the application. For this reason, the wet spray application method is not suited to spray application under the hot environment, and it is often the case that the dry spray application method is used under the hot environment.

As a spray material used for the dry spray application method (unshaped refractory material for dry spray application), a magnesium limestone-containing spray material is disclosed in the following Patent Document 1. However, as a result of hot spray application performed using the magnesium limestone-containing spray material by the present inventors, it has been found that there remains a need for improvement, particularly in terms of corrosion resistance.

### CITATION LIST

### [Parent Document]

Patent Document JP S58-145660 A

### SUMMARY OF INVENTION

### Technical Problem

A problem to be solved by the present invention is to improve corrosion resistance, in a spray material for hot and dry spray application, and a hot and dry spray application method.

### Solution to Technical Problem

As a result of various researches conducted to improve corrosion resistance in a spray material for hot and dry spray application, and a hot and dry spray application method, particularly with a focus on slag penetration resistance, the present inventors have found that magnesium limestone having a particle size of 0.075 mm to less than 1 mm largely contributes to improvement of slag penetration resistance, and have come to accomplish the present invention.

According to one aspect of the present invention, there is provided a spray material for hot and dry spray application, which comprises a refractory material and a binder, wherein the spray material contains magnesium limestone having a particle size of 0.075 mm to less than 1 mm, in an amount of 10 mass % to 50 mass %, in 100 mass % of a total amount of the refractory material and the binder, and wherein a content of magnesium limestone having a particle size of less than 0.075 mm in 100 mass % of the total amount of the refractory material and the binder is 35 mass % or less (including 0).

According to another aspect of the present invention, there is provided a hot and dry spray application method which comprises pressure-feeding a mixture comprising a refractory material and a binder, toward a spraying nozzle via a pipe, and adding water to the mixture at a distal end of the spraying nozzle to apply a spray under a hot condition, wherein the mixture contains magnesium limestone having a particle size of 0.075 mm to less than 1 mm, in an amount of 10 mass % to 50 mass %, in 100 mass % of a total amount of the refractory material and the binder, and wherein a content of magnesium limestone having a particle size of less than 0.075 mm in 100 mass % of the total amount of the refractory material and the binder is 35 mass % or less (including 0).

It should be noted that the term “particle size” in the present invention means a sieve mesh size when refractory material particles are screened and separated by a sieve. For example, the magnesium limestone having a particle size of less than 0.075 mm means a magnesium limestone particle which can pass through a sieve having a mesh size of 0.075 mm, and the magnesium limestone having a particle size of 0.075 mm or more means a magnesium limestone particle which cannot pass through the sieve having a mesh size of 0.075 mm.

### Effect of Invention

According to the present invention, the content of the magnesium limestone having a particle size of 0.075 mm to less than 1 mm is set in a specific range, thereby providing improved slag penetration resistance, and thus providing improved corrosion resistance.

### BRIEF DESCRIPTION OF DRAWINGS

FIG. 1 is an explanatory diagram showing an evaluation method for adhesiveness.

### DESCRIPTION OF EMBODIMENTS

A spray material for hot and dry spray application contains magnesium limestone having a particle size of 0.075 mm to less than 1 mm (hereinafter referred to as “magnesium limestone with a medium particle size” or “medium particle size magnesium limestone”) in an amount of 10 mass % to 50 mass %, in 100 mass % of a total amount of the refractory material and the binder (hereinafter referred to as “the total amount”)

Assume that the spray material is applied to form a lining of an industrial kiln/furnace. In this case, when the magnesium limestone (CaCO₃.MgCO₃) with a medium particle size receives heat caused by operation of the industrial kiln/furnace, voids are formed in the inside thereof, and high-reactive free CaO is formed, through a degassing reaction (CaCO₃.MgCO₃→CaO.MgO+2CO₂). Thus, slug penetrating from a working surface of the lining is trapped by the formed voids, and further reacts with the free CaO to form a high melting point composition “2CaO.SiO₂” (melting point: 2130° C.), thereby suppressing penetration of slag.

If the content of the medium particle size magnesium limestone is less than 10 mass %, a slag penetration suppressing effect (slug penetration resistance improving effect) is not sufficiently brought out, and thus a sufficient corrosion resistance improving effect cannot be obtained. On the other hand, if the content of the medium particle size magnesium limestone is greater than 50 mass %, voids (open pores) are excessively formed through the degassing reaction, and thus slug penetration is undesirably encouraged, leading to deterioration in corrosion resistance.

The content of the medium particle size magnesium limestone is preferably 20 mass % to 40 mass %, in 100 mass % of the total amount.

The spray material of the present invention may contain magnesium limestone having a particle size of less than 0.075 mm (hereinafter referred to as “magnesium limestone with a fine particle size” or “fine particle size magnesium limestone”).

Here, in the fine particle size magnesium limestone, CaO is formed through the aforementioned degassing reaction. Since this CaO is formed from the fine particle size magnesium limestone having a relatively large contact area with water, it is more likely to develop a hydration reaction (CaO+2H₂O→Ca²⁺+2OH⁻), and Ca²⁺ formed through the hydration reaction reacts with the binder and others. Thus, the CaO is deemed to contribute to bonding enhancement (strength enhancement) of a matrix of a spray-applied body, but not to contribute to the aforementioned formation of a high melting point composition.

However, if the fine particle size magnesium limestone is excessively contained, the influence of the aforementioned degassing reaction (influence of void formation) becomes stronger than the aforementioned matrix binding enhancing (strength enhancing) action, so that voids excessively formed in the matrix portion will lead to significant deterioration in strength of the spray-applied body (spray-applied body strength) and further leads to deterioration in corrosion resistance of the spray-applied body. Therefore, the content of the fine particle size magnesium limestone in 100 mass % of the total amount is set to 35 mass % or less (including 0).

On the other hand, the fine particle size magnesium limestone brings out the matrix binding enhancing (strength enhancing) action as mentioned above, and thus, from a viewpoint of positively utilizing this matrix portion bonding enhancing (strength enhancing) action to improve adhesiveness (adhesiveness between the spray material and a to-be-applied surface, after the industrial kiln/furnace starts operation since completion of the spray application), the content of the fine particle size magnesium limestone in 100 mass % of the total amount is preferable set to 5 mass % to 35 mass %, more preferably 5 mass % to 25 mass %.

The spray material of the present invention may contain magnesium limestone having a particle size of 1 mm or more (hereinafter referred to as “magnesium limestone with a coarse particle size” or “coarse particle size magnesium limestone”). However, in the coarse particle size magnesium limestone, relatively large voids are formed through the aforementioned degassing reaction. Thus, when the coarse particle size magnesium limestone is contained in a large amount, slag penetration is promoted, leading to the tendency of corrosion resistance to deteriorate. Therefore, the content of the coarse particle size magnesium limestone in 100 mass % of the total amount is preferably set to 50 mass % or less (including 0).

As above, the aforementioned slag penetration suppressing effect (slug penetration resistance improving effect) of the present invention can be obtained by setting the content of the magnesium limestone with each particle size, particularly the medium particle size magnesium limestone, to a specific range.

As a refractory material other than magnesium limestone, the spray material of the present invention may include any of various refractory materials which have been commonly used in spray materials. However, considering compatibility with magnesium limestone, it is preferable to mainly use a basic refractory material (basic oxide) such as magnesia, olivine (peridot), or used magnesia-carbon based brick waste. Examples of a refractory material other than the basic refractory material may include alumina.

As the binder, it is possible to use any of various binders which have been commonly used in spray materials for dry spray application. Examples thereof include phosphate, silicate, pitch, powder resin, and alumina cement. Typically, a binder containing at least one selected from phosphate and silicate is used. Examples of phosphate include sodium phosphate, potassium phosphate, lithium phosphate, calcium phosphate, magnesium phosphate, and aluminum phosphate, and examples of silicate include sodium silicate, potassium silicate, and calcium silicate. Further, the usage amount (content) of the binder may be set in a similar manner to that for commonly-used in spray materials for dry spray application. For example, it may be set to 1 mass % to 10 mass % in 100 mass % of the total amount.

It is noted that the binder may be used in combination with an additive. As the additive, it is possible to use any of various additives such as a hardener, a dispersant, and a thickener. For example, it is possible to use slaked lime, phosphate, and clay, respectively, as the hardener, the dispersant, and the thickener.

The above spray material of the present invention is offered to a hot and dry spray application method which comprises pressure-feeding a mixture comprising the refractory material and the binder as mentioned above, toward a spraying nozzle via a pipe, and adding water to the mixture at a distal end of the spraying nozzle to apply a spray under a hot condition,

An addition amount of water may be set in a similar manner to that in a commonly-used hot and dry spray application method. For example, it may be set to 10 mass % to 40 mass % with respect to and in addition to 100 mass % of the total amount.

### EXAMPLES

Table 1 shows a material composition and an evaluation result of each of Inventive Examples and Comparative Examples, in regard to the spray material of the present invention. In Table 1, “Others” means clay, slaked lime, disperser, and others. Evaluation items and an evaluation method are as follows.

### <Corrosion Resistance>

A spray material for hot and dry spray application, in each Example, was applied from a spraying nozzle to the surface of a magnesia brick heated up to 1000° C. to serve as a to-be-applied surface, at a spraying amount of 15 kg/minute for one minute. In this process, the amount of water to be added at a distal end of the spraying nozzle was set to 20 mass % with respect to and in addition to 100 mass % of the total amount.

As a result of the spray application for one minute, a spray-applied body comprised of the spray material applied in a thickness of approximately 50 mm was obtained. A sample cut from this spray-applied body to have a given size was subjected to corrosion at a temperature of 1650 to 1700° C. for 3 hours in a rotary corrosion tester using synthetic slag having C/S=1.0, as a corrosive agent. A maximum wear amount in each Example was measure, and, on the assumption that the maximum wear amount in Inventive Example 1 is 100, a relative amount was obtained for each of the remaining Examples. A smaller relative value means higher corrosion resistance (slag penetration resistance). In the evaluation of corrosion resistance, a sample having a relative value of 100 or less was evaluated as ⊚ (Good), and a sample having a relative value of greater than 100 to 110 was evaluated as ∘ (Allowable). Further, a sample having a relative value of greater than 110 was evaluated as x (NG).

### <Spray-Applied Body Strength>

The sample cut from the spray-applied body in each Example to have the given size in the aforementioned manner was subjected to measurement of compressive strength at normal temperatures in accordance with JIS 82575, and, on the assumption that the measured compressive strength in Inventive Example 1 is 100, a relative amount was obtained for each of the remaining Examples. A larger relative value means higher spray-applied body strength. In the evaluation of spray-applied body strength, a sample having a relative value of 80 or more was evaluated as ⊚ (Good), and a sample having a relative value of 70 to less than 80 was evaluated as ∘ (Allowable). Further, a sample having a relative value of less than 70 was evaluated as x (NG).

### <Adhesiveness>

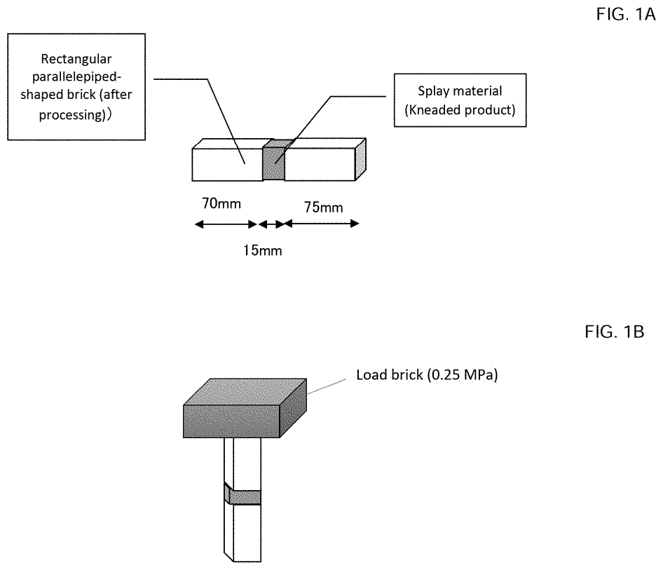

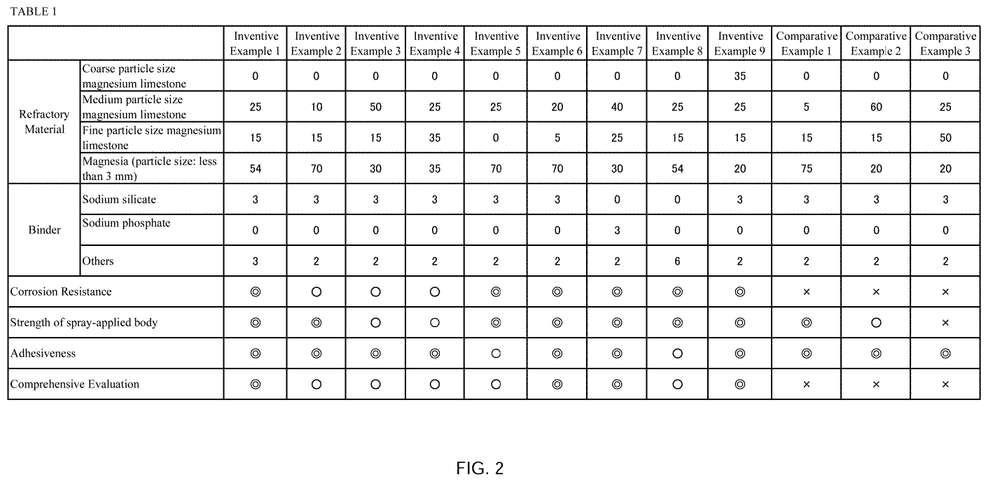

As shown on the upper side of FIG. 1, a 15 mm space was provided in a longitudinally middle region of a rectangular parallelepiped-shaped magnesia brick. Then, a kneaded product obtained by adding water (in an amount of 20 mass % with respect and in addition to 100 mass % of the total amount) to the spray material in each Example, and kneading the resulting mixture was cast in the space, and subjected to curing and drying. Then, as shown on the lower side of FIG. 1, the obtained rectangular parallelepiped-shaped magnesia brick was subjected to burning at 1400° C. for 3 hours in a state in which a load of 0.25 MPa was applied from a top edge of the brick, to obtain a test piece. For the test piece for each Example, a bending strength of adhered surfaces was measured by a three-point bending test, and, on the assumption that the measured bending strength in Inventive Example 1 is 100, a relative amount was obtained for each of the remaining Examples. A larger relative value means higher adhesiveness. In the evaluation of adhesiveness, a sample having a relative value of 100 or more was evaluated as ⊚ (Good), and a sample having a relative value of greater than 60 to less than 100 mass % was evaluated as ∘ (Allowable).

This evaluation result of adhesiveness serves as an index indicative of adhesion strength between the spray material and the to-be-applied surface, after the industrial kiln/furnace starts operation since completion of actual spray application.

### <Comprehensive Evaluation>

A sample in which all the evaluation items were evaluated as ⊚ was comprehensively evaluated as ⊚ (Good), and a sample in which no evaluation item was evaluated as x, and any one of the evaluation items was evaluated as ◯ was comprehensively evaluated as ∘ (Allowable). Further, a sample in which any one of the evaluation items was evaluated as x was comprehensively evaluated as x (NG). This comprehensive evaluation result serves an index indicative of durability of an actual spray-applied body.

TABLE 1

[symbol]

[symbol]

indicates data missing or illegible when filed

Inventive Examples 1 to 9 are spray materials for hot and dry spray application, each of which falls within the scope of the present invention as set forth in the appended claims. In each Inventive Example, the comprehensive evaluation was ⊚ (Good) or ∘ (Allowable), i.e., a good result could be obtained.

Comparative Example 1 is an example in which the content of the medium particle size magnesium limestone is excessively small. In this example, the slag penetration suppressing effect (slug penetration resistance improving effect) could not be sufficiently obtained, and therefore the evaluation of corrosion resistance was x (NG).

Comparative Example 2 is an example in which the content of the medium particle size magnesium limestone is excessively large. In this example, voids (open pores) were excessively formed through the aforementioned degassing reaction, and thus slag penetration was undesirably encouraged, so that the evaluation of corrosion resistance was x (NG).

Comparative Example 3 is an example in which the content of the fine particle size magnesium limestone is excessively large. In this example, voids were excessively formed in a matrix of the sample due to an influence of the aforementioned degassing reaction, so that the evaluations of corrosion resistance and spray-applied body strength were x (NG).

1. A spray material for hot and dry spray application, comprising a refractory material and a binder, wherein the spray material contains magnesium limestone having a particle size of 0.075 mm to less than 1 mm, in an amount of 10 mass % to 50 mass %, in 100 mass % of a total amount of the refractory material and the binder, and wherein a content of magnesium limestone having a particle size of less than 0.075 mm in 100 mass % of the total amount of the refractory material and the binder is 35 mass % or less (including 0).

2. The spray material according to claim 1, wherein the binder contains at least one selected from phosphate and silicate.

3. The spray material according to claim 1, wherein the content of the magnesium limestone having a particle size of less than 0.075 mm is 5 mass % to 35 mass %.

4. A hot and dry spray application method comprising pressure-feeding a mixture comprising a refractory material and a binder, toward a spraying nozzle via a pipe, and adding water to the mixture at a distal end of the spraying nozzle to apply a spray under a hot condition, wherein the mixture contains magnesium limestone having a particle size of 0.075 mm to less than 1 mm, in an amount of 10 mass % to 50 mass %, in 100 mass % of a total amount of the refractory material and the binder, and wherein a content of magnesium limestone having a particle size of less than 0.075 mm in 100 mass % of the total amount of the refractory material and the binder is 35 mass % or less (including 0).

5. The spray material according to claim 2, wherein the content of the magnesium limestone having a particle size of less than 0.075 mm is 5 mass % to 35 mass %.
